(19) United States
(12) Patent Application Publication
(10) Pub. No.: US 2006/0072902 A1
(43) Pub. Date: Apr. 6, 2006

(54) Method of recording a program comprised in a television signal

(75) Inventor: Benjamin Novi, Paris (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,848

(22) PCT Filed: Nov. 24, 2003
(86) PCT No.: PCT/IB03/05373

§ 371 Date: May 31, 2005

(30) Foreign Application Priority Data
Dec. 4, 2002 (FR) 0215288

(51) Int. Cl. H04N 5/76; G06F 13/00; G06F 3/00

(52) U.S. Cl. 386/83; 725/58

(57) ABSTRACT

The invention relates to a method of recording a program comprised in a television signal. A television signal comprises program information including the real starting hour of at least a following program. The method comprises the steps of: —memorizing a theoretical starting hour of the program to be recorded (30);—defining, among the following programs, a retained program satisfying a criterion of concordance relating to at least the memorized theoretical starting hour of the program to be recorded and the real starting hour of the subsequent program included in the program information comprised in the television signal (32); and—recording the television signal on the basis of the real starting hour of the retained program (34).

### FIELD OF THE INVENTION

The invention relates to a method of recording a program broadcast on a data transmission channel.

The invention also relates to a decoder and to a recording device suitable for performing the method.

### BACKGROUND OF THE INVENTION

Video recording equipment such as video recorders are equipped with programming means allowing the recording of a program.

These programming means notably allow entry of the theoretical starting hour of the program, as well as the theoretical ending hour of the program. The recording is triggered at the programmed theoretical starting hour and this recording stops at the programmed theoretical ending hour.

During their broadcast, the programs may be slightly shifted with respect to time and their durations may vary. Certain programs may thus have been recorded only partially if they start before the programmed theoretical starting hour or end after the programmed theoretical ending hour.

The current receivers, decoders and/or digital television recorders comprise electronic program guides (EPG). Such an electronic program guide allows reception of information relating to the start and the end of coming programs. This information is transmitted by the station broadcasting the program, simultaneously with the present program.

In accordance with the DVB standard (“Digital Video Broadcasting”), the real ending hour of the present program as well as the real starting and ending hours of the following program is transmitted periodically. Optionally, the real starting and ending hours of subsequent programs may also be transmitted.

This information is transmitted in an EIT table (“Event Information Table”).

In such digital television systems, the programming of the recording device for the programs, whose real starting and ending hours have already been transmitted by the broadcasting station, is realized by direct selection of the program to be recorded in accordance with the electronic program guide. The recording device is thus exactly started at the real starting hour of the program and stopped at the real ending hour of the program.

However, the real starting and ending hours of subsequent programs are only transmitted for a limited number of programs. These programs may be spread over only two successive programs, only one day or only several days.

If the program which the user wishes to record is situated within a period of time beyond programs whose starting and ending hours are transmitted, the recording device must be programmed on the basis of theoretical starting and ending hours. These hours are known, for example, by reading magazines giving the program timetables.

As explained hereinbefore, certain parts of the program to be recorded cannot be recorded in the case of temporal program shifts caused by the broadcasting station.

### OBJECT AND SUMMARY OF THE INVENTION

It is an object of the invention to propose a solution to the problem of possible non-recording of certain parts of a program to be recorded and, inversely, to the problem of recording a part of the end of the program preceding the program to be recorded when, at the instant of programming the recording, the real timetables of starting and ending the program to be recorded have not yet been transmitted by the broadcasting station.

To this end, it is an object of the invention to provide a method of recording a program comprised in a television signal, the television signal comprising program information including the real starting hour of at least a following program, characterized in that said method comprises the steps of:
memorizing a theoretical starting hour of the program to be recorded;
defining, among the following programs, a retained program satisfying a criterion of concordance relating to at least the memorized theoretical starting hour of the program to be recorded and the real starting hour of the following program included in the program information comprised in the television signal; and
recording the television signal on the basis of the real starting hour of the retained program.

In accordance with a particular embodiment, the method may comprise one or several of the following characteristic features:
said transmitted program information comprises a real ending hour of the program, and said method comprises the steps of:
searching, during recording of the television signal corresponding to the retained program, a real ending hour of the program in said program information transmitted for the retained program, and
stopping the recording at said real ending hour of the retained program;
said transmitted program information comprises an indicator of the development of the present program, and said method comprises the steps of:
following said indicator of the development of the present program, and
stopping the recording of the television signal during the absence of the indicator of the development of the present program in said transmitted program information,
said transmitted program comprises a real ending hour of the program, and said method comprises a step of:
memorizing a theoretical ending hour of the program to be recorded, and said concordance criterion also relates to the memorized theoretical ending hour of the program to be recorded and to the real ending hour of the retained program included in the program information comprised in the television signal,
said concordance criterion is defined, for example, by the existence of a temporal overlap between the broadcast timetable for the following program and that defined between the theoretical starting hour and the theoretical ending hour whose duration exceeds the broadcast timetable of the following program by more than 70%.

The invention also relates to a device for recording a program comprised in a television signal, the television signal comprising program information including the real starting hour of at least a following program, and is characterized in that said device comprises:
means for memorizing a theoretical starting hour of the program to be recorded;
means for defining, among the following programs, a retained program satisfying a criterion of concordance relating to at least the memorized theoretical starting hour of the program to be recorded and the real starting hour of the following program included in the program information comprised in the television signal, and
means for recording the television signal on the basis of the real starting hour of the retained program.

The invention also relates to a television signal decoder, in which the television signal comprises program information including the real starting hour of at least a following program, and is characterized in that said decoder comprises:
means for memorizing a theoretical starting hour of the program to be recorded;
means for defining, among the following programs, a retained program satisfying a criterion of concordance relating to at least the memorized theoretical starting hour of the program to be recorded and the real starting hour of the following program included in the program information comprised in the television signal, and
means for controlling the recording of the television signal on the basis of the real starting hour of the retained program.

Finally, the invention relates to a computer program product for a data processing unit, comprising a set of instructions for performing the steps of the method as described above, when said program is performed by a data processing unit.

### BRIEF DESCRIPTION OF THE DRAWINGS

The invention will be better understood by reading the following description, solely given by way of example, and referring to the drawings in which:

FIG. 1 is a diagrammatic view of a digital television receiving and recording system;

FIGS. 2 and 3 are respective simplified and detailed flow charts of the method according to the invention;

FIGS. 4, 5 and 6 are diagrams of a digital television broadcast timetable, considered at successive instants.

### DESCRIPTION OF EMBODIMENTS

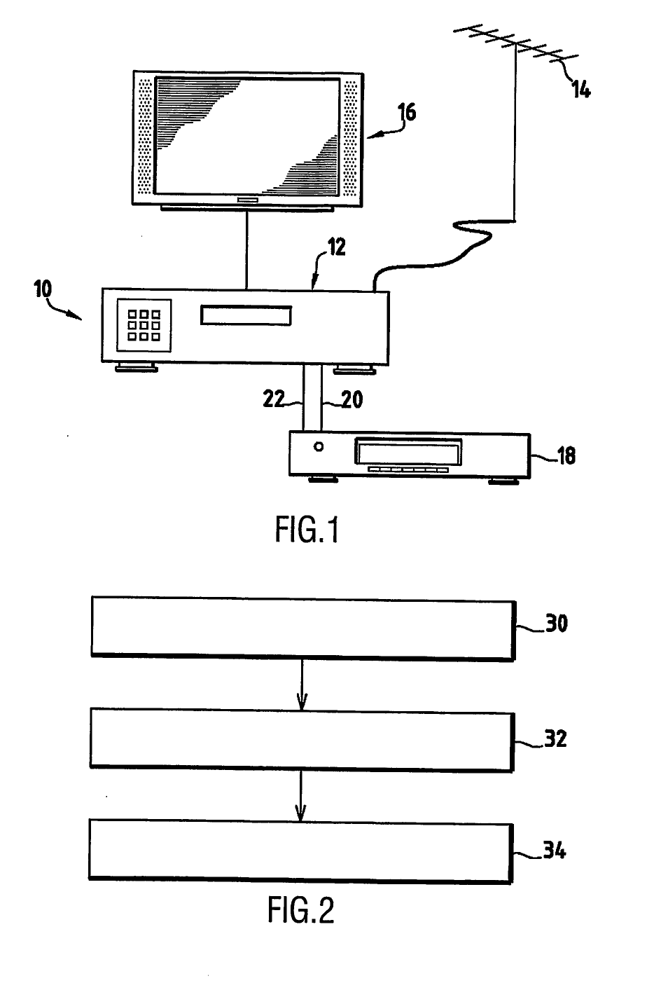

The digital television receiving and recording system illustrated in FIG. 1 comprises a decoder 12 connected to a receiving antenna 14. The decoder 12 is connected to a television screen 16 for displaying images and for reproducing sound received in the television signal.

The installation also comprises a recording device 18, such as a video recorder. This device is connected to the decoder 12 by means of a connection 20 for transmitting the decoded television signal, and by means of a line 22 for transmitting control signals. These control signals are notably constituted by start and stop signals addressed by the decoder 12 to the recording device 18 in order to control the start of a recording and the end of this recording, respectively.

As is known per se, the decoder 12 is adapted to receive a television signal in accordance with the DVB standard and to process this signal.

The following description is given while considering the DVB standard. However, the invention may be used with any other transmission standard for a television signal, such as the ATSC standard in which the signal comprises information for starting and ending programs.

This television signal comprises data constituting the actual television programs and program information regrouping the characteristic information of the present program and of one or several following programs.

In this description, the term program designates an event in the sense of the DVB standard.

This program information is included in an EIT table. It comprises notably, for each program, its real starting hour and its real ending hour, such as are evaluated by the broadcasting station at the instant of transmitting the program information.

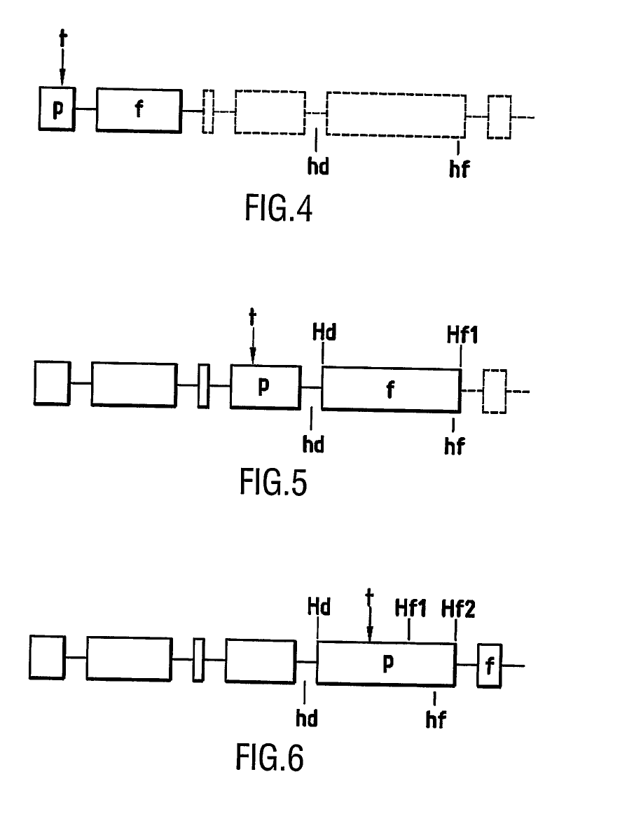

In accordance with the DVB standard, this information is transmitted at least for the present program, denoted by p (for “present”, in conformity with the DVB terminology), in FIGS. 4 and 6 and for the immediately following program, denoted by f (for “following”, in conformity with the DVB terminology) in these Figures.

In the following description, this program information is not supposed to be transmitted for the present program and the following program only.

The decoder 12 comprises means for receiving the television signal and for decoding this signal, and for forming the program data to be used by the television 16 and the recorder 18.

The decoder 12 comprises means for processing program information and notably for compiling, in the received signal, real starting hours and real ending hours transmitted for the present program p and the following program f.

The decoder 12 also comprises an internal clock allowing the determination of the current hour which is synchronized with the received television signal.

As is known per se, the decoder 12 comprises programming means for recording a future program. These means notably comprise a remote control allowing the entry of a theoretical starting hour of the program to be recorded and a theoretical ending hour of the program to be recorded.

Advantageously, the decoder 12 also comprises a module forming an electronic program guide allowing a user easy access to different accessible programs and to information on future programs.

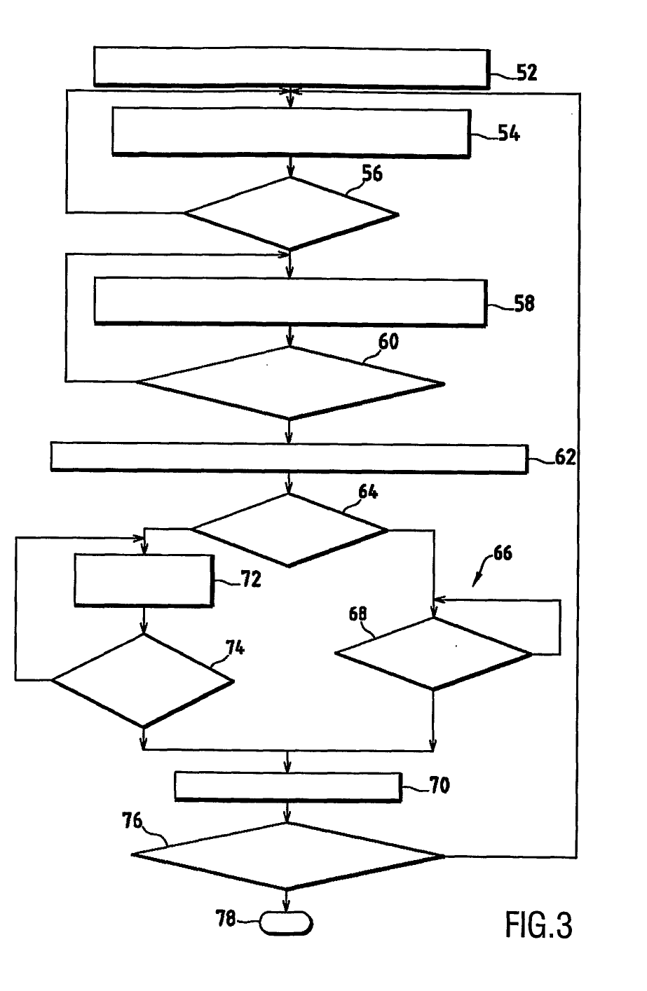

For recording a program, the decoder 12 uses the general flow chart illustrated in FIG. 2.

For recording a program comprised in a television signal, the method memorizes, in step 30, a theoretical starting hour of the program to be recorded; subsequently defines, in step 32, among the following programs, a program satisfying a criterion of concordance relating to at least the memorized theoretical starting hour of the program to be recorded and to the real starting hour of the program; and finally records, in step 34, the concordant program retained for the real starting hour of the program satisfying the criterion.

In step 52, the theoretical starting hour denoted hd and the theoretical ending hour denoted h_{f} are acquired by the user of the remote control. They are memorized by the decoder.

The theoretical starting and ending hours h_{d} and h_{f} are illustrated in FIG. 4. In this Figure, the successive programs transmitted by the television broadcasting station are represented by rectangles. These programs are spread over a period of time which is supposed to run from left to right.

In FIGS. 4, 5 and 6, the programs shown in solid lines are those whose program information is received at the instant denoted t. The other programs, whose program information is not yet received at the instant t under consideration, are represented in broken lines.

In FIG. 4, at the instant t, only the present program, denoted by p, and the following program, denoted by f, have program information which is known to the decoder 12. This information is the only information which is transmitted compulsorily.

Particularly, for the subsequent program which must be recorded, the decoder 12 does not yet have the disposal of the real starting and ending hours.

In step 54, the decoder evaluates whether the following program, for which it knows the real starting and ending hours, satisfies a criterion of concordance with the memorized theoretical starting and ending hours. This program is designated as retained program in the following description.

To this end, the decoder 12 compares the program information received for the following program with the memorized theoretical starting and ending hours.

The concordance criterion is defined, for example, by the existence of a temporal overlap between the broadcast timetable for the following program and the timetable defined between the theoretical starting hour and the theoretical ending hour whose duration exceeds the broadcast timetable of the following program by more than 70%.

If there is no concordance, the theoretical hours will be used for recording.

In step 56, a test is performed so as to determine whether a concordant program may have been determined. If this is not the case, the step 54 is performed again in the loop.

As soon as a following program satisfying the concordance criterion is identified, the real starting hour, denoted H_{d} is determined in the program information of the retained program. The present situation is illustrated in FIG. 5, in which the instants h_{d} and H_{d} are shifted.

A test is carried out, in step 60, for determining whether the real starting hour H_{d} is reached. As long as the real starting hour H_{d} is not reached, the step 58 is used so as to determine a possible modification of the real starting hour H_{d} in the periodically transmitted program information.

When the real starting hour H_{d} is equal to the current hour, the recording is started in step 62. To this end, a recording order is given by the decoder 12 to the recording device 18.

In step 64, the decoder determines whether during broadcasting of the retained program, the broadcasting station transmits status information indicating that the program is running.

If this is the case, a loop 66 is initiated. This loop is maintained as long as the status information indicating that the program is running is received. To this end, a test is performed, in step 68, verifying the reception of the status information. When this information is no longer received, a term is set to the recording, in step 70. To this end, a command is given by the decoder 12 to the recording device 18.

In contrast, when no status information showing that the program is running is transmitted during the test in step 64, step 72 of searching the real ending hour denoted H_{f} is performed. This real ending hour is included in the EIT program information which is continuously transmitted by the broadcasting station.

As long as the real ending hour considered at the present instant is not equal to or earlier than the current hour, step 72 is performed on the basis of the test performed in step 74.

Step 72 is thus constantly used during the period of broadcasting the program so that, in case of modification of the duration of the program during its broadcast, a new real ending hour denoted H_{f2} in FIG. 6 is received by the decoder and taken into account in step 74, by replacing the previously considered real ending hour H_{f2} (FIG. 5).

When the current hour reaches the real ending hour, the recording is stopped in step 70.

At the start of the recording process, a test is performed in step 76 so as to determine whether the programmed theoretical ending hour H_{f} is later than the current hour.

If this is not the case, step 54 and the following steps are again performed so as to ensure the recording of the following program if the concordance criterion is satisfied by the following program.

If this is the case, a term is set to the algorithm in step 78.

It will be obvious that with such a process as illustrated in FIG. 5, the recording of the desired program starts at the real starting hour H_{d}, even if this hour is different from the theoretical starting hour hd.

Similarly, and as illustrated in FIG. 6, the recording stops at the real ending hour H_{f}, even if this hour is different from the theoretical ending hour h_{f}.

In the envisaged embodiment, the means ensuring the use of the algorithm are included in the decoder 12. Alternatively, they may also be directly integrated in the video recording device 18. In another variant, they may be integrated in the television 16.

The means allowing use of the method generally resort to a computer program which, when used on a computer of the decoder, the recording device, the television receiver or any other data system ensures the execution of the method.

1. A method of recording a program comprised in a television signal, the television signal comprising program information including the real starting hour of at least a following program, characterized in that said method comprises the steps of:
memorizing a theoretical starting hour of the program to be recorded;
defining, among the following programs, a retained program satisfying a criterion of concordance relating to at least the memorized theoretical starting hour of the program to be recorded and the real starting hour of the following program included in the program information comprised in the television signal; and
recording the television signal on the basis of the real starting hour of the retained program.

2. A method as claimed in claim 1, wherein said transmitted program information includes a real ending hour of the program, characterized in that said method comprises the steps of:
searching, during recording of the television signal corresponding to the retained program, a real ending hour of the program in said program information transmitted for the retained program, and
stopping the recording at said real ending hour of the retained program.

3. A method as claimed in claim 1, wherein said transmitted program information includes an indicator of the development of the present program, characterized in that said method comprises the steps of:
following said indicator of the development of the present program, and
stopping the recording of the television signal during the absence of the indicator of the development of the present program in said transmitted program information.

4. A method as claimed in claim 1, wherein said transmitted program information includes a real ending hour of the program, characterized in that said method comprises a step of memorizing a theoretical ending hour of the program to be recorded, and in that said concordance criterion also relates to the memorized theoretical ending hour of the program to be recorded and to the real ending hour of the retained program in the program information comprised in the television signal.

5. A method as claimed in claim 4, characterized in that said concordance criterion is defined, for example, by the existence of a temporal overlap between the broadcast timetable for the following program and that defined between the theoretical starting hour and the theoretical ending hour whose duration exceeds the broadcast timetable of the following program by more than 70%.

6. A device for recording a program comprised in a television signal, the television signal comprising program information including the real starting hour of at least a following program, characterized in that said device comprises:
means for memorizing a theoretical starting hour of the program to be recorded;
means for defining, among the following programs, a retained program satisfying a criterion of concordance relating to at least the memorized theoretical starting hour of the program to be recorded and the real starting hour of the following program included in the program information comprised in the television signal, and
means for recording the television signal on the basis of the real starting hour of the retained program.

7. A television signal decoder, wherein the television signal comprises program information including the real starting hour of at least a following program, characterized in that said decoder comprises:
means for memorizing a theoretical starting hour of the program to be recorded;
means for defining, among the following programs, a retained program satisfying a criterion of concordance relating to at least the memorized theoretical starting hour of the program to be recorded and the real starting hour of the following program included in the program information comprised in the television signal, and
means for controlling the recording of the television signal on the basis of the real starting hour of the retained program.

8. A computer program product for a data processing unit, comprising a set of instructions for performing the steps of the method as claimed in any one of the dependent claims, when said program is performed by a data processing unit.
